(19) United States
(12) Patent Application Publication
(10) Pub. No.: US 2019/0266897 A1
(43) Pub. Date: Aug. 29, 2019

(54) DRONE USAGE IN CONNECTED USER AND CONNECTED FLEET COMMUNICATION AND INTERFACE SYSTEMS

(71) Applicant: AVIS BUDGET CAR RENTAL, LLC, Parsippany, NJ (US)

(72) Inventor: JOHN TURATO, PARSIPPANY, NJ (US)

(21) Appl. No.: 16/256,501

(22) Filed: Jan. 24, 2019

Related U.S. Application Data
(60) Provisional application No. 62/621,074, filed on Jan. 24, 2018.

(51) Int. Cl. G08G 1/00; G05D 1/00; B64C 39/02; G06Q 30/06; H04L 9/06

(52) U.S. Cl. CPC G08G 1/202; G05D 1/0027; B64C 39/024; H04L 2209/38; H04L 9/0643; B64C 2201/127; G06Q 30/0645

(57) ABSTRACT

A system and related methods for management of communications and interactions between a user and a connected fleet of vehicles. Fleet vehicle reservations and rental transaction systems are blockchain-based systems, which incorporate customer interaction, including payments through customary payment channels and/or cryptocurrency, through customer personal computers and/or mobile devices. One or more unmanned aerial vehicles (drones) may be used to respond to accidents to fleet vehicles on the road, and document with digital images damage to the fleet vehicle or other vehicles, as well as road conditions and environmental factors.

This application claims benefit of and priority to U.S. Provisional Application No. 62/621,074, filed Jan. 24, 2018, which is incorporated herein in its entirety by specific reference for all purposes.

### FIELD OF INVENTION

This invention relates to a system and related methods for management of communications and interfacing between a user and a connected fleet of vehicles.

### BRIEF DESCRIPTION OF THE DRAWINGS

FIG. 1 illustrates the system architecture of a mobile device used to communicate with a vehicle and reservation server of a connected fleet.

FIG. 2 illustrates a portion of a mobile device user interface displaying a map of vehicle locations

FIG. 3 illustrates a portion of a mobile device user interface displaying information regarding the vehicles available at a selected location.

FIG. 4 illustrates a portion of a mobile device user interface for selecting a “favorite” vehicle or vehicle type.

FIG. 5 illustrates a mobile device user interface for recording damage to a vehicle.

FIG. 6 illustrates a mobile device user interface for reviewing and electronically signing an invoice.

FIG. 7 shows a diagram of a blockchain-based reservation system.

FIG. 8 shows a diagram of a blockchain-based vehicle rental system.

FIG. 9 shows an example of a blockchain interface panel.

FIG. 10 a diagram of a unmanned aerial vehicle (drone) being used for accident assessment.

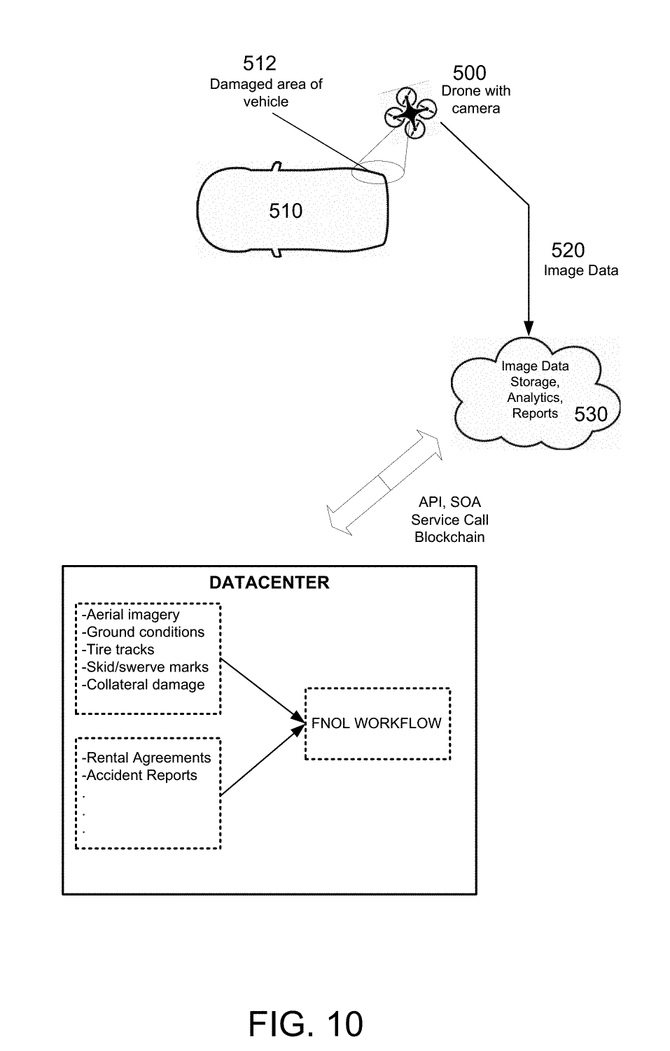

### DETAILED DESCRIPTION OF EXEMPLARY EMBODIMENTS

In various exemplary embodiments, the present invention comprises a system and related methods for management of communications and interactions between a user and a connected fleet of vehicles. A “connected fleet” comprises a plurality of vehicles, some or all equipped with (i) on-board sensors and computer systems for monitoring and capturing the operational status and performance of vehicle systems and components, and (ii) one or more electronic control and/or communications units for two-way or multiple pathway communication with one or more fleet management servers or networks, outside data centers or sources, other vehicles, and individual user or driver computing devices. A “connected user” comprises a user with one or more computing devices, including, but not limited to, mobile computing devices such as smart phones, tablets, or wearable devices, that provide extended, continuous, uninterrupted electronic communications with various computer networks, devices, and systems, including, but not limited to, elements of the connected fleet computing system or network, regardless of where the user is and how they are connected. Connected users may include, but are not limited to, drivers, passengers, customers, renters, members of a vehicle sharing service, employees, owners, or operators.

Vehicles in a connected fleet may include, but are not limited to, automobiles, trucks, vans, buses, motorcycles, bicycles, mopeds, construction and utility vehicles, battery-powered carts, golf carts, airplanes, aircraft, boats, watercraft, and the like. Vehicles may be controlled by a driver or user, or autonomous or semi-autonomous. A fleet may include, but is not limited to, a rental vehicle fleet, shared vehicle fleet, peer-to-peer or business-to-business transportation fleet, taxi-cab fleet, corporate vehicle fleet, municipal or governmental agency vehicle fleet, bus fleet, utility or construction vehicle fleet, truck fleet, or combinations thereof. A fleet may be homogenous or heterogeneous (i.e., a mixed fleet). Fleets may be combined to make larger fleets, and fleets may also be sub-divided into component fleets by various parameters (e.g., type of use, type of customer or user, country, state, city, county, or other defined geographical area). The term “fleet” as used herein includes fleets of all types and various combinations, components or sub-divisions thereof.

As described in detail below, in several embodiments the present invention comprises a unique, single integrated platform for communications between a connected user and a connected fleet management system. The connected fleet management system manages fleet planning, in-fleeting operations, vehicle acquisition and provisioning, vehicle assignment, vehicle transfers (i.e., to another fleet or another component fleet in the larger fleet), vehicle use operations (i.e., reservations, use and return by a customer, member, driver or user), vehicle servicing, vehicle maintenance and repairs, and de-fleeting operations (e.g., removal of the vehicle from the fleet, return to manufacturer, or sale to third parties).

Within this context, the system provides a variety of user-facing applications and interfaces, including applications which may be installed and run on a mobile computing device of the user for various functions. These functions include, but are not limited to, user registration or enrollment, user reservation management, user access to a fleet vehicle, communication between the user and the fleet management system during use (including, but not limited to, providing roadside or emergency assistance), and return of the fleet vehicle.

In several exemplary embodiments, the present invention comprises one or more systems or applications for enrolling or registering users. Types of users vary depending on the nature of the fleet. For example, users may be employees of the owner of a corporate or municipal utility fleet, authorized drivers of a bus fleet, drivers of taxi-cabs, renters or customers of a car rental agency, or members of a car sharing service. Accordingly, the types of user registration or enrollment system will vary as well.

In general, the user enrollment or registration component collects necessary information from the users, and reviews potential users backgrounds and qualifications, including, but not limited to, user training, licensure reviews, background checks, and credit checks, as appropriate. In some business models, enrollment may comprise an application and acceptance as a member of a car sharing or similar service. Advertising or other means of solicitation of potential users may be included. In some cases, users may not be previously enrolled prior to an initial reservation or use, and some or all of these checks may be performed at the time the user reserves a vehicle or initially takes possession of a vehicle.

Users of a particular fleet may be divided into different categories or classifications (e.g., a preferred or frequent driver program for a car rental company, or users licensed for certain types of vehicles). In several embodiments, the system may comprise a “trusted user” program, where the user has meet certain pre-qualifications and undergone substantive background and credit checks. A “trusted user” may receive certain advantage and perquisites, such as access to special vehicles, quicker and easier access to vehicles, and quicker and easier returns.

In several embodiments, the present invention further comprises one or more reservation systems or applications. These comprise both user-facing and internal fleet system elements. An example of a multi-tiered fleet management reservations database caching system is described in U.S. Pat. No. 9,576,254 (issued Feb. 21, 2017 to Zipcar, Inc.), which is incorporated herein by specific reference for all purposes. Examples of a reservations interface for a user to identify available vehicles and make a reservation are provided in U.S. Pub. No. 2013/0226633 (published Aug. 29, 2013 by Zipcar, Inc.) and U.S. Pub. No. 2011/0060480 (published Mar. 10, 2011 by Zipcar, Inc.), which are incorporated herein by specific reference for all purposes.

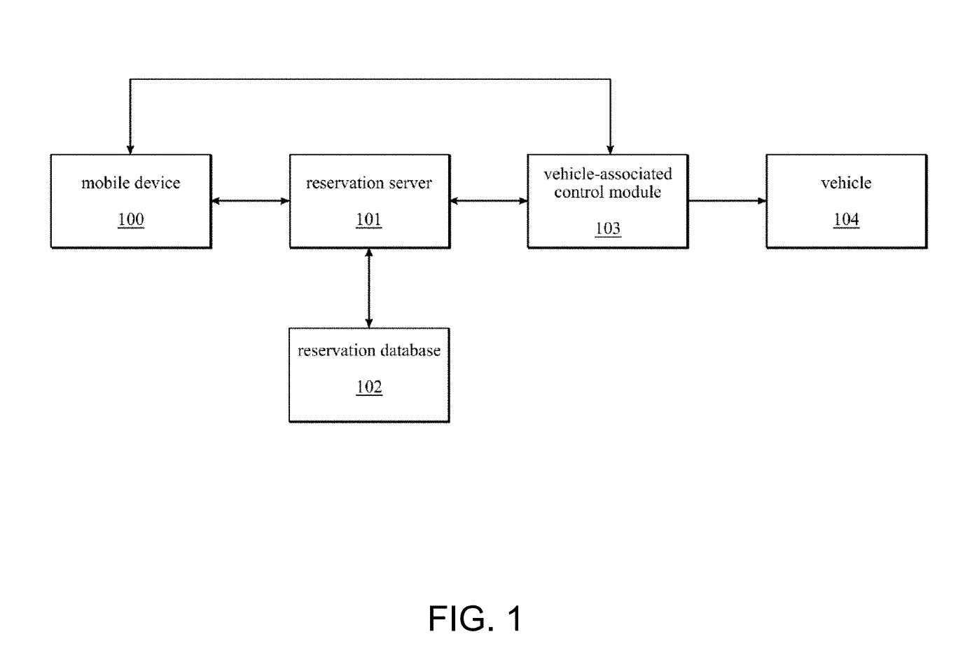

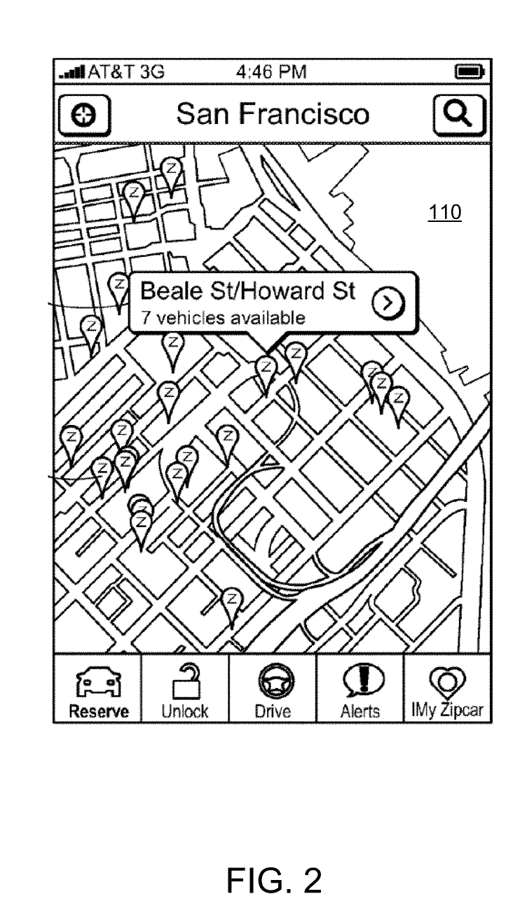

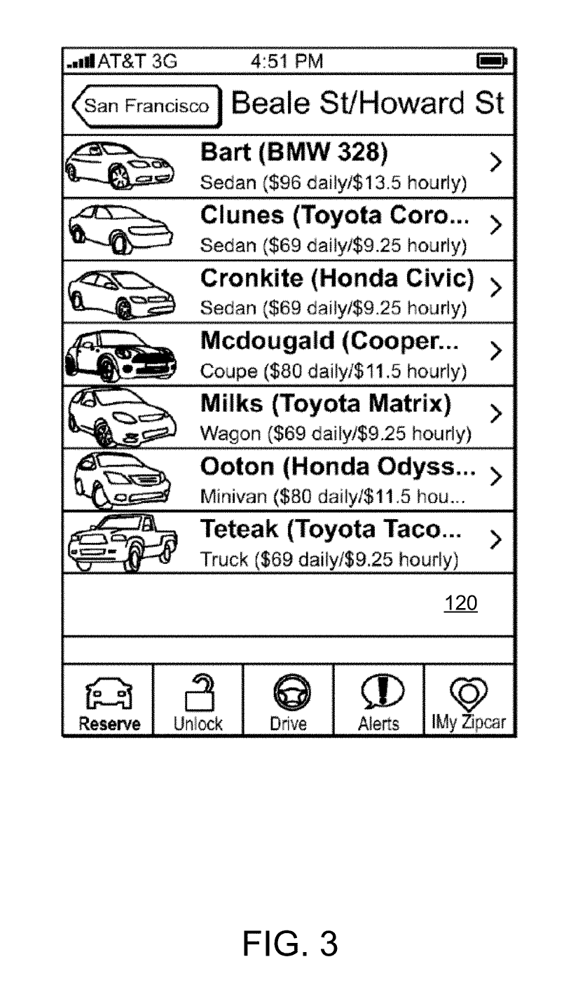

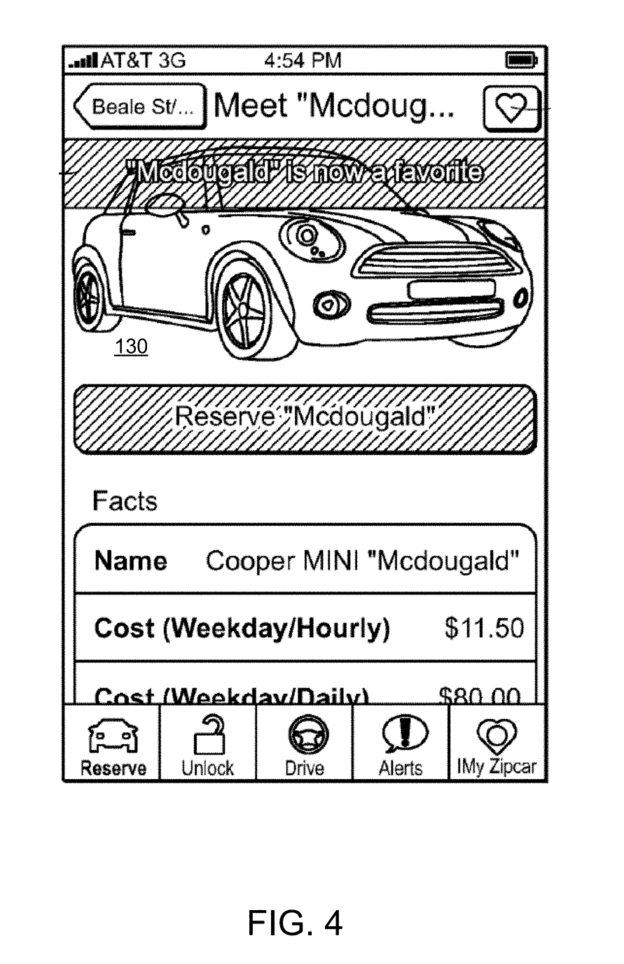

In one exemplary embodiment, for example, as seen in FIG. 1, a mobile device 100 runs a mobile device application for reserving and accessing a reservable asset, such as a vehicle 104. The mobile device application can be installed on the mobile device or it can be accessed through a web application. The mobile device electronically communications with a reservation server 101 that is part of a connected fleet management system. The reservation server is in communication with a reservation database 102. The reservation server provides information about reservable vehicles to the mobile device, including reservable assets (typically for a requested time period and location of interest). The mobile device application may display a map 110 of locations of reservable vehicles, enabling users to search and view locations as desired, as seen in FIG. 2. The mobile device application also may display reservable vehicles in list format 120, as seen in FIG. 3. Users may mark certain vehicle types, or specific vehicles, as a “favorite,” 130 as seen in FIG. 4, for facilitating future searches.

The present invention further comprises a vehicle access component, that also may comprise both user-facing and internal fleet system elements. This may be part of the reservations system or work in conjunction with a reservations system. The user seeks access in a variety of ways, including, but not limited to, obtaining keys to the vehicle from a car rental agent, presenting an authorized user card to a card reader in the vehicle, or using a mobile computing device to communicate with a TCU or dedicated access unit in the vehicle, as discussed above. Examples of access control systems are disclosed in U.S. Pat. No. 9,442,888 (issued Sep. 13, 2016 to Zipcar, Inc.) and U.S. Pat. No. 9,635,518 (issued Apr. 25, 2017 to Avis Budget Car Rental, LLC), which are incorporated herein by specific reference for all purposes.

In cases where the user is attempting key-less access to a connected vehicle, such as by wireless communication with a user's mobile computing device, there are several methods to determine whether to allow access. In some cases, access may be permitted if the user is a pre-authorized registered user, and presents a general access code or authorization to the vehicle. In other cases, reservation data (either for a single reservation or for reservations over a period of time, which can be a day or several days) has been previously electronically communicated to the vehicle (e.g., transmitted to a TCU in the vehicle) and stored therein, and access is permitted if a user attempting access matches corresponding reservation data (i.e., user identity, time period, and the like). Alternatively, after receiving an access request from a user, the vehicle (i.e., through TCU or similar unit) electronically communicates with the fleet management system to confirm whether or not to allow access. In cases where the vehicle cannot establish direct communication access, it may attempt to establish communication through other connected vehicles, through the user's mobile device, or other wireless access points.

In some cases, such as an underground garage or parking area, the vehicle and user's computing device may be unable to establish outside communications links in any fashion. In several embodiments, the fleet management system of the present invention previously provides a protected, secure, single-use token to the user's computing device upon making a reservation (or close to the starting time of the reservation), which is then securely communicated to the vehicle by the user's computing device through local wireless communications means (e.g., BLE, NFC, and the like). The vehicle processes the token, and allows access if the information in the token is valid.

After access is allowed, the period of use commences. During use, as described above, the connected vehicle (or a TCU or a similar unit in the vehicle) provides various information to the fleet management system. The fleet management system may directly or indirectly monitor some or all of the period of use.

In several embodiments, the fleet management system monitors the period of use for emergency situations, which may be reported by the user through an application on the user's mobile device or a unit in the vehicle. The user can establish connection directly with the fleet management system or an road-side assistance or emergency response team or service, and request assistance.

In several embodiments, the user may communicate an incident or accident in real-time or near real-time during the use period. Information may be gathered in real time by the user using the application on their mobile computing device, including descriptions and pictures of any damage to the vehicle. This information can then be provided to the fleet management system's servicing or maintenance components for advance planning and scheduling prior to return of the vehicle.

The user may be contacted if the fleet management system detects that the vehicle may be returned late, or at a different location than identified in the reservation, as described in U.S. Pub. No. 2013/0246102 (published Sep. 19, 2013 by Zipcar, Inc.) which is incorporated herein by specific reference for all purposes. The fleet management system can assist the user in extending or modifying the reservation if necessary, and may contact other users that may be affected by the late return.

The present invention further comprises vehicle return applications or components, which handle, among other things, determination of the vehicle status and condition, invoicing of the user (where appropriate), and forwarding of the vehicle for any servicing, maintenance, or repairs that may be required. These also may comprise user-facing and internal fleet elements. For example, a user may return a vehicle to a planned drop-off location, then automatically check-in through an application on their mobile computing device. The user may be prompted to confirm mileage and gas levels (which the connected vehicle may communicate directly to the fleet management system), and electronically sign the final invoice. An electronic receipt may be sent to the user through the application, email, or other form of electronic communication.

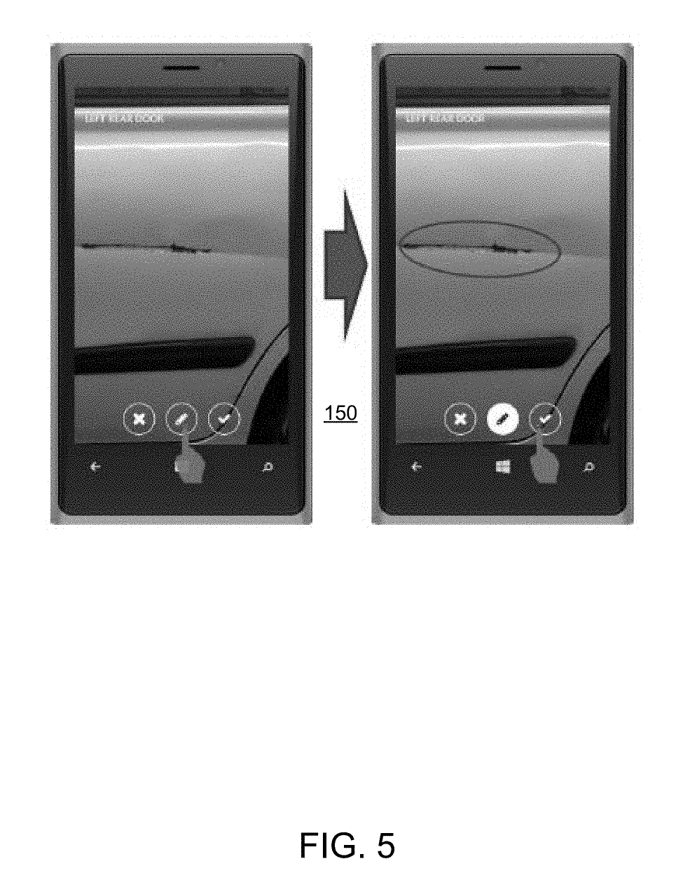

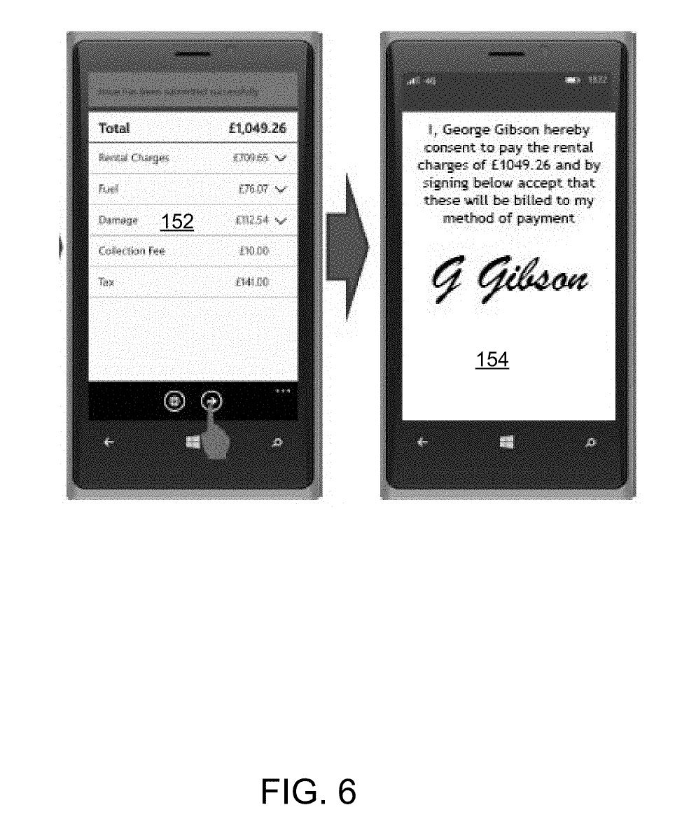

If the vehicle is damaged, the application may be used to record/photograph the damage 150, as seen in FIG. 5, and the system may then automatically, in real time, calculate a damage charge 152 to add to the user invoice at the time of return. The mobile device may be used to capture the electronic signature 154 of the customer or user returning the vehicle, as seen in FIG. 6, including the damage charge.

Blockchain-Based System

In several embodiments, some or all of the applications described herein are carried out used a blockchain-based distributed database system. In general, a blockchain consists of a series of blocks which are generated with and protected by a cryptographic method. Each block contains a hash value of a previous block, so the blockchain is formed through connections from an originating block through a series of block to the current block. The system ensures that each block is generated after a previous block in chronological order.

Blockchain-based systems originated with digital currency implementations, particularly Bitcoin, which was initially described in the whitepaper “Bitcoin: A Peer-to-Peer Electronic Cash System,” authored under the pseudonym Satoshi Nakamoto, dated Oct. 31, 2008 (a copy of which is attached as an appendix to the provisional application to which this application claims priority, and is incorporated herein by specific reference for all purposes). Since that time, blockchain-based systems have been described for use in other contexts. Examples of such systems are disclosed in the following published patent applications, all of which are incorporated herein by specific reference for all purposes: US Pub. 2017/0346833 (Nov. 30, 2017); US Pub. 2017/0295157 (Oct. 12, 2017); US Pub. 2017/0228822 (Aug. 10, 2017); US Pub. 2017/0230189, (Aug. 10, 2017); US Pub. 2017/0031874 (Feb. 2, 2017); US Pub. 2016/0292672 (Oct. 6, 2016); and US Pub. 2015/0332283 (Nov. 19, 2015).

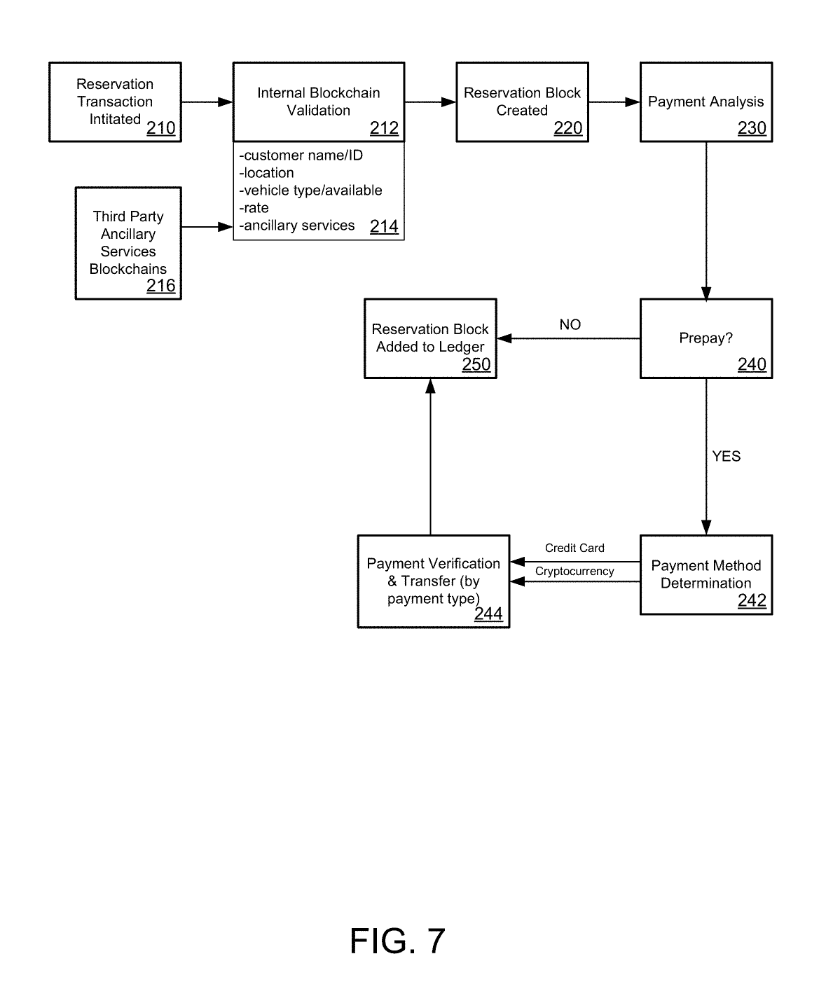

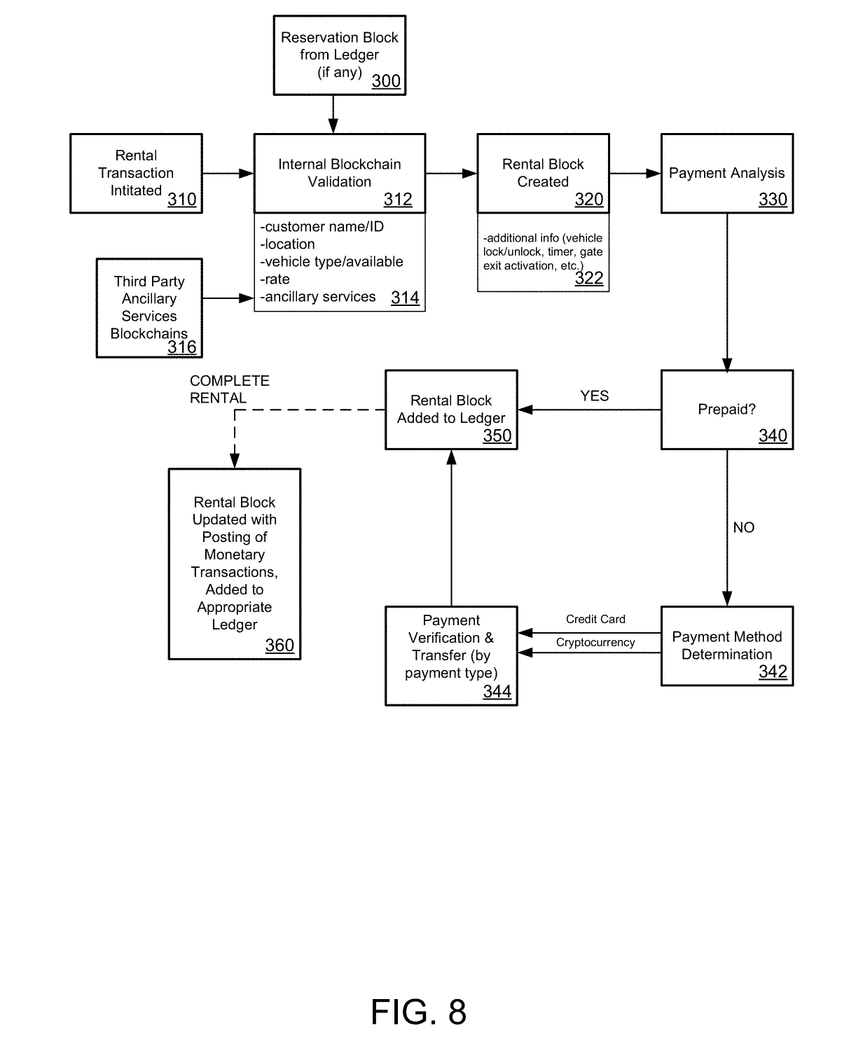

In various exemplary embodiments, as seen in FIGS. 7 and 8, the reservations and rental transaction systems described above are blockchain-based systems, which incorporate customer interaction through customer personal computers and/or mobile devices. For a reservation system, as seen in FIG. 7, a customer initiates a reservation transaction 210, which launches into an internal private blockchain structure. The system receives and validates 212 the various elements 214 of the proposed reservation transaction, including, but not limited to, customer name/ID, rental location(s) (e.g., pick-up and drop-off), rental dates and times, vehicle type and availability, vehicle rental rate, and ancillary services or features 216. Payment information (e.g., credit card or debit card number, cryptocurrency information, expiration date, billing address, verification code, pre-payment amount, and the like) may also be provided, whether for pre-payment or post-rental payment. A reservation block 220 containing all pertinent data concerning the reservation contract is created.

The reservation block may then be subsequently analyzed for determination and of subsequent actions, including but not limited to payment method 230. In several embodiments, a normal reservation requires no payment analysis (i.e., no pre-payment is made), and the reservation block is added 250 to the blockchain ledger for logging and notification to the customer. A pre-pay reservation 240 requires determination of the method of payment 242 from the reservation block. Standard credit card transactions flow through existing verification processes 244, and are then added to the blockchain ledger 250. Cryptocurrency transactions flow through the appropriate cryptocurrency clearing systems where the distributed network of verifiers process the transaction 244 and transfer the cryptocurrency funds (e.g., Bitcoin), which is then added to the blockchain ledger 250.

Following the reservation transaction, the customer may at the appropriate time initiate the rental transaction 310, as seen in FIG. 8, with validation 312 of elements 314 the same as or similar to the reservation transaction, including ancillary services 316. If a reservation had been made, the data from the reservation block is incorporated and updated as necessary with additional information (such as actual rental location, actual vehicle, customer driver's license number and related information, and so on). A rental block containing all pertinent data for the rental transaction is created as part of the blockchain 320. After validation, the rental block contains contractual details, elements, and rental functions and capabilities 322, such as, but not limited to, vehicle lock/unlock, gate exit activation indicators, transaction timer (e.g., days/hours/minutes), and ancillary services or products. Payment analysis 330 is performed. If the rental was prepaid 340 through the reservation block, the prepay rental flows through to completion and the rental block is added to the ledger 350. If not prepaid, standard credit card transactions or cryptocurrency transactions are determined 342 and verified and cleared 344 in a similar fashion as described above, with the payment transaction being added to the blockchain ledger 350. Upon completion of the rental, all monetary transactions are posted to the blockchain, logged, and applied to the appropriate rental or other company ledger 360.

The above systems also allow third party sellers or vendors, which can be anonymous, to offer and provide ancillary services and products 216, 316 to a customer through an external public blockchain structure. Customers can select and approve the addition of desired ancillary services and products to a reservation and/or rental transaction block. The sellers or vendors may provide the ancillary services and product information through publically available API interfaces made available through the reservation/rental systems. Ancillary item transactions can be paid for using standard credit card or cryptocurrency processes as described above. Ancillary item information approved is added to the appropriate block(s) in the blockchain.

The blockchain-based systems described above allow for more streamlined processing with lower transaction costs. New transaction channels (e.g., cryptocurrency) are added to prior art systems. The blockchain-based systems also invite participation by new business participants or partners that have not been involved in prior art vehicle rental systems.

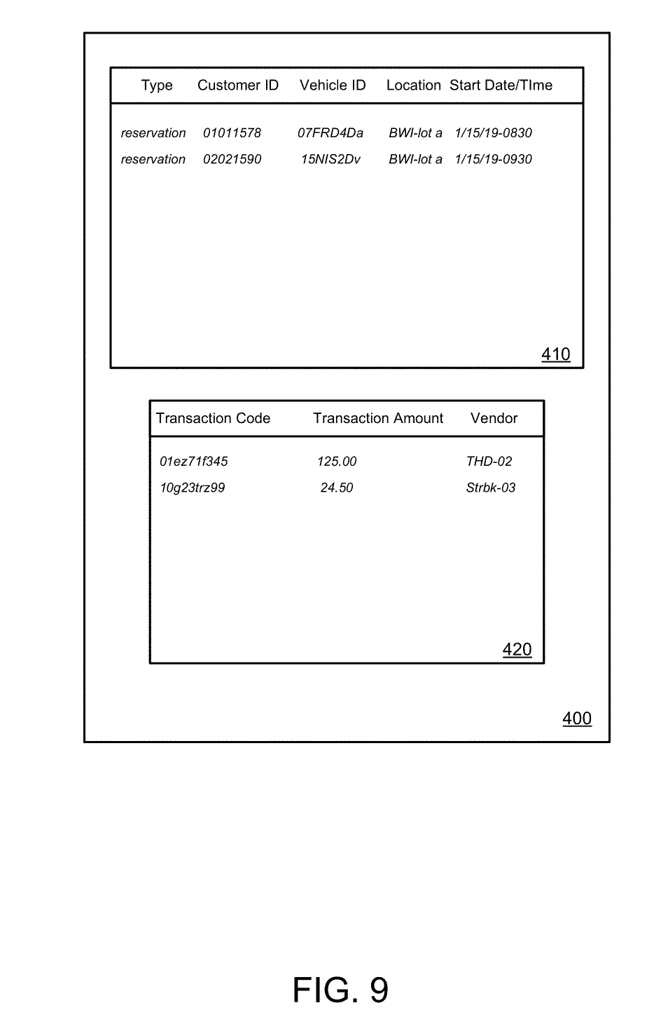

FIG. 9 shows an example of an Blockchain interface 400, which may be presented to users through an Internet web browser or similar application program. In the embodiment shown, the interface 400 comprises a block table, list or stream 410 and a transaction table, list or stream 420. The block table display data regarding reservation or rental actions and/or transactions which are compiled into blocks. The block table can be organized, sorted, filtered, and/or searched by a variety of parameters, including, but not limited to, block type, customer name/ID, location, vehicle ID, vehicle type, and the like. The transaction table displays event and/or transaction records, which are updated in real-time as the events occur or transactions are conducted. As above, this table can be organized, sorted, filtered, and/or searched by a variety of parameters. Transactions records, for example, include, but are not limited to, a unique transaction identification code (which can be a hash code), an amount associated with the transaction, and a merchant or vendor associated with the transaction.

Drone Usage

In several exemplary embodiments, as seen in FIG. 9, one or more unmanned aerial vehicles, or drones, are used to respond to emergency situations, or capture imagery of vehicles that have been involved in an accident or damaged in some other way, such as a hail storm, hurricanes, tornados, floods, or other acts of nature. Drones of various configurations and sizes may be used. Examples of drones and related control systems are disclosed in U.S. Pat. No. 8,474,761 (issued Jul. 2, 2013), U.S. Pat. No. 9,359,074 (issued Jun. 7, 2016), U.S. Pat. No. 9,868,526 (issued Jan. 16, 2018), and U.S. Pat. No. 10,181,152 (issued Jan. 15, 2019), all of which are incorporated herein in their entireties by specific reference for all purposes.

As noted above, the fleet management system monitors the period of use for emergency situations, which may be reported by the user through an application on the user's mobile device or a unit in the vehicle. In addition to establishing connection directly with the users and dispatching a road-side assistance or emergency response team or service, the system also may dispatch or send one or more aerial drones 500 to the location of the vehicle 510. The routing and flight of the drone or drones is according to various means and systems known in the prior art. The drone may deliver equipment, supplies or other materials to the user or other individuals at the vehicle location, including, but not limited to, food, water, medical supplies, tools, replacement parts, keys, documents or other papers, batteries, and fuel.

In the case of an accident, the drone is equipped with a camera and/or videocamera, and is dispatched to take high definition video and/or pictures of the vehicle(s) and accident site, including not only the vehicle(s) involved and close-ups of the vehicle damage 512, but also road conditions (e.g., wet pavement, tire tracks, rubber marks, and the like), location appearance and information (e.g., GPS), weather conditions, elevation and slope, associated collateral damage, and the like. A variety of sensors may also be carried on the drone, in addition to the camera and/or videocamera.

Data collected (including, but not limited to, image data such as digital pictures and/or video) may be stored on digital storage devices on the drone. Data also may be sent via wireless communications 520 from the drone and stored in a remote server database, “cloud” environment, or other digital storage means for subsequent analysis and reporting 530.

One or more drones also may be used during vehicle returns at a return location, as discussed above, for damage assessment and other documentation during the return. An example of a return assessment system is described in U.S. patent application Ser. No. 15/934,887, filed Mar. 23, 2018, and is incorporated herein in its entirety by specific reference for all purposes. Drone assessment may be of particular use for automatic check-in returns, as described above.

One or more drones also may be used for monitoring of fleet facilities and lots, including assessment of damage to vehicles in fleet lots after a hail storm, hurricanes, tornados, floods.

Stored data, including image and video data, is accessed (such as by service call, API, or private blockchain), parsed, and analyzed to provide specific information related to various needs. Accelerating data collection and analysis of damage to vehicles, for example (e.g., near real time data collection and analysis relative to an accident or damage-causing incident), can combine with both connected user and connected-fleet management systems to provide faster notice of loss and faster, more concise information to claims adjusters. Data retrieval and handling can be done via private blockchain, as discussed below. Greater operational efficiencies lead to faster claims processing and faster recovery of monies.

Connected Fleet Interaction

More detailed information about interactions between connected users and a connected fleet management system (including various applications and interfaces), and examples thereof, are disclosed in U.S. patent application Ser. No. 15/986,375, filed May 22, 2018, and U.S. patent application Ser. No. 15/986,504, filed May 22, 2018, both of which are incorporated herein in their entireties by specific reference for all purposes.

Computer Implementation

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions, and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like), or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

As used herein, the singular forms “a,” “an” and “the” include plural referents unless the context clearly dictates otherwise. Further, the terms “additional”, “optional”, “optionally”, “may” and the like mean that the subsequently described operation, event or functionality mayor may not be required, and that the description includes instances where said operation, event or functionality occurs and instances where it does not. The word “comprise” and variations of that word, and the word “include” and variations of that word, mean “including but not limited to,” and are not intended to exclude, for example, other components, steps, or operations. “For example” and “exemplary” mean “an example of” and are not intended to convey an ideal embodiment.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. The system, methods and apparatus of the present invention are not limited to specific components, network connections, or arrangements described and disclosed herein, as such may vary. It is also to be understood that the terminology used herein is for the purpose of describing particular embodiments only, and is not intended to be limiting. Even though specific embodiments of this invention have been described, they are not to be taken as exhaustive. There are several variations that will be apparent to those skilled in the art.

What is claimed is:

1. A method for inspecting fleet vehicle damage, comprising:
providing a connected fleet comprising a plurality of connected fleet vehicles;
providing one or more unmanned aerial vehicles, each with at least one camera or videocamera;
in the event of an accident involving one of said plurality of connected fleet vehicles, dispatching at least one of said one or more unmanned aerial vehicles to the location of the accident; and
taking one or more digital photographs or video recordings of any damage to the vehicle.

2. The method of claim 1, further comprising the steps of:
taking one or more digital photographs or video recordings of any other vehicles involved in the accident; and
taking one or more digital photographs of video recordings of the road conditions in the vicinity of the accident.

3. The method of claim 1, further comprising the steps of:
storing the digital photographs or video recordings on a data storage device on the unmanned aerial vehicle.

4. The method of claim 3, further comprising the steps of:
wireless transmitting the digital photographs or video recordings to a remote server database or remote digital storage means.

5. The system of claim 1, wherein the connected fleet is a vehicle rental fleet.

6. The system of claim 1, wherein the connected fleet is a shared vehicle fleet.
